(19) United States
(12) Patent Application Publication
(10) Pub. No.: US 2026/0060411 A1
(43) Pub. Date: Mar. 5, 2026

(54) SUBSTRATE PROCESSING APPARATUS

(71) Applicant: SAMSUNG ELECTRONICS CO., LTD., Suwon-si (KR)

(72) Inventors: Jae Hyeon LIM, Suwon-si (KR); Ho Young KIM, Suwon-si (KR); Ki Hyun Park, Suwon-si (KR); Jong Sung PARK, Suwon-si (JP); Jun Hwan YIM, Suwon-si (KR); Seung Hoon CHOI, Suwon-si (KR); Hyung Ho CHOI, Suwon-si (KR)

(73) Assignee: SAMSUNG ELECTRONICS CO., LTD., Suwon-si (KR)

(21) Appl. No.: 19/024,520

(22) Filed: Jan. 16, 2025

(30) Foreign Application Priority Data
Aug. 30, 2024 (KR) 10-2024-0117456

(51) Int. Cl. A46B 13/04; A46B 9/00; A46B 13/00; A46B 15/00; B08B 1/12; B08B 1/20; B08B 1/36; B08B 1/40; B08B 13/00; H01L 21/67

(52) U.S. Cl. CPC A46B 13/04; A46B 9/005; A46B 13/008; A46B 15/0004; B08B 1/12; B08B 1/20; B08B 1/36; B08B 1/40; B08B 13/00; A46B 2200/3073

(57) ABSTRACT

A substrate processing apparatus may include: a substrate including a first face and a second face that are opposite to each other; a substrate driver configured to come into contact with a peripheral part of the substrate, and provide a driving force to the substrate to rotate the substrate; a first brush that faces the first face, and is configured to clean the first face by coming into contact with the first face and rotating in a first direction; a second brush that faces the second face, and is configured to clean the second face by coming into contact with the second face and rotating in the first direction; and a controller configured to control at least one from among the substrate driver, the first brush, and the second brush.

### CROSS-REFERENCE TO RELATED APPLICATION

This application claims priority from Korean Patent Application No. 10-2024-0117456, filed on Aug. 30, 2024 in the Korean Intellectual Property Office, and all the benefits accruing therefrom under 35 U.S.C. 119, the disclosure of which is herein incorporated by reference in its entirety.

### BACKGROUND

Embodiments of the present disclosure relate to a semiconductor processing apparatus.

When manufacturing a substrate, semiconductor elements are manufactured through many processes such as a vapor deposition process, a polishing process, and an etching process. After the aforementioned processes are performed, a cleaning process of removing foreign matters such as unnecessary thin films and particles remaining on the substrate is performed.

In particular, since many foreign matters remain on a surface of the substrate subjected to a chemical mechanical polishing process (CMP), a cleaning process of multi-stages is performed to remove the foreign matters. A method for uniformly removing the foreign matters remaining on the surface of the substrate is being sought.

### SUMMARY

According to embodiments of the present disclosure, a substrate processing apparatus that may uniformly clean a substrate may be provided.

According to embodiments of the present disclosure, a substrate processing apparatus may be provided and include: a substrate including a first face and a second face that are opposite to each other; a substrate driver configured to come into contact with a peripheral part of the substrate, and provide a driving force to the substrate to rotate the substrate; a first brush that faces the first face, and is configured to clean the first face by coming into contact with the first face and rotating in a first direction; a second brush that faces the second face, and is configured to clean the second face by coming into contact with the second face and rotating in the first direction; and a controller configured to control at least one from among the substrate driver, the first brush, and the second brush, wherein the first brush includes a first cleaning face configured to come into contact with the first face, and wherein the second brush includes a second cleaning face configured to come into contact with the second face.

According to embodiments of the present disclosure, a substrate processing apparatus may be provided and include: a first brush including a first cleaning face; a second brush including a second cleaning face, the second brush spaced apart from the first brush; a substrate between the first brush and the second brush, the substrate including a first face that faces the first cleaning face, and a second face that faces the second cleaning face; a substrate driver configured to come into contact with a peripheral part of the substrate, and provide a driving force to the substrate to rotate the substrate; and a controller configured to control at least one from among the substrate driver, the first brush, and the second brush, wherein the first cleaning face is configured to come into contact with an entirety of the first face, wherein the second cleaning face is configured to come into contact with an entirety of the second face, and wherein a width of the first cleaning face is greater than a width of the first face, and a width of the second cleaning face is greater than a width of the second face.

According to embodiments of the present disclosure, a substrate processing apparatus may be provided and include: a substrate including a first face and a second face that are opposite to each other; a substrate driver configured to come into contact with a peripheral part of the substrate, and provide a driving force to the substrate to rotate the substrate; a first brush including a first cleaning face that faces the first face of the substrate, the first cleaning face configured to clean the first face of the substrate by coming into contact with the first face and rotating in a first direction; a second brush including a second cleaning face that faces the second face of the substrate, the second cleaning face configured to clean the second face of the substrate by coming into contact with the second face and rotating in the first direction; a first driver configured to rotate the first brush in the first direction; a second driver configured rotate the second brush in the first direction; an injector configured to provide a cleaning solution to the first brush and the second brush; and a controller configured to control at least one from among the substrate driver, the first brush, and the second brush, wherein a width of the first cleaning face is greater than a width of the first face, wherein a width of the second cleaning face is greater than a width of the second face, wherein the first driver is configured to rotate the first brush around a first rotary axis, wherein the second driver is configured to rotate the second brush around a second rotary axis that is the same as the first rotary axis, and wherein the substrate driver is configured to rotate the substrate around a third rotary axis that is different from the first rotary axis.

However, aspects of embodiments of the present disclosure are not restricted to the one set forth herein. The above and other aspects of embodiments of the present disclosure will become more apparent to one of ordinary skill in the art to which the present disclosure pertains by referencing the detailed description of the present disclosure given below.

### BRIEF DESCRIPTION OF DRAWINGS

The above and other aspects and features of embodiments of the present disclosure will become more apparent by describing in detail non-limiting example embodiments thereof with reference to the attached drawings, in which:

FIG. 1 is a cross-sectional view for explaining a substrate processing apparatus according to some embodiments of the present disclosure.

FIG. 2 is a perspective view for explaining the substrate processing apparatus according to some embodiments of the present disclosure.

FIG. 3 is a perspective view for explaining a brush of FIG. 1.

FIG. 4 is a cross-sectional view for explaining a substrate processing apparatus according to an embodiment of the present disclosure.

FIG. 5 is a perspective view for explaining the substrate processing apparatus of FIG. 4, according to an embodiment of the present disclosure.

FIGS. 6 and 7 are cross-sectional views for explaining a substrate processing apparatus according to an embodiment of the present disclosure.

FIG. 8 is a perspective view for explaining the brush of FIGS. 6 and 7.

FIG. 9 is a perspective view for explaining a brush according to an embodiment of the present disclosure.

FIG. 10 is a perspective view for explaining a brush according to an embodiment of the present disclosure.

FIG. 11 is a perspective view for explaining a brush according to an embodiment of the present disclosure.

FIG. 12 is a perspective view for explaining a brush according to an embodiment of the present disclosure.

FIG. 13 is a perspective view for explaining a brush according to an embodiment of the present disclosure.

FIG. 14 is a perspective view for explaining a brush according to an embodiment of the present disclosure.

FIG. 15 is a perspective view for explaining a brush according to an embodiment of the present disclosure.

FIG. 16 is a perspective view for explaining a brush according to an embodiment of the present disclosure.

FIG. 17 is a perspective view for explaining a brush according to an embodiment of the present disclosure.

FIG. 18 is a perspective view for explaining a brush according to an embodiment of the present disclosure.

### DETAILED DESCRIPTION

Although terms such as “first” and “second” are used to describe various constituent elements in the present specification, these constituent elements are not limited by these terms. These terms are only used to distinguish a single constituent element from another constituent element. Therefore, a first constituent element referred to below may be a second constituent element within the scope of the present disclosure.

It will be understood that when an element or layer is referred to as being “on,” “connected to,” or “coupled to” another element or layer, it can be directly on, connected to, or coupled to the other element or layer or intervening elements or layers may be present. In contrast, when an element or layer is referred to as being “directly on,” “directly connected to,” or “directly coupled to” another element or layer, there are no intervening elements or layers present.

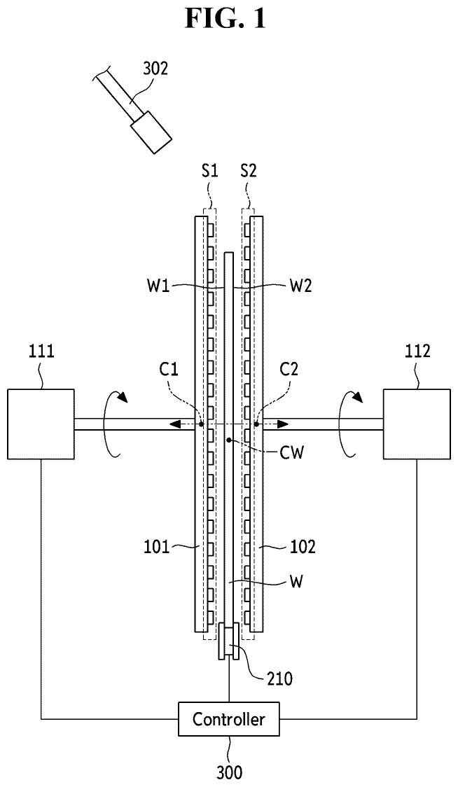

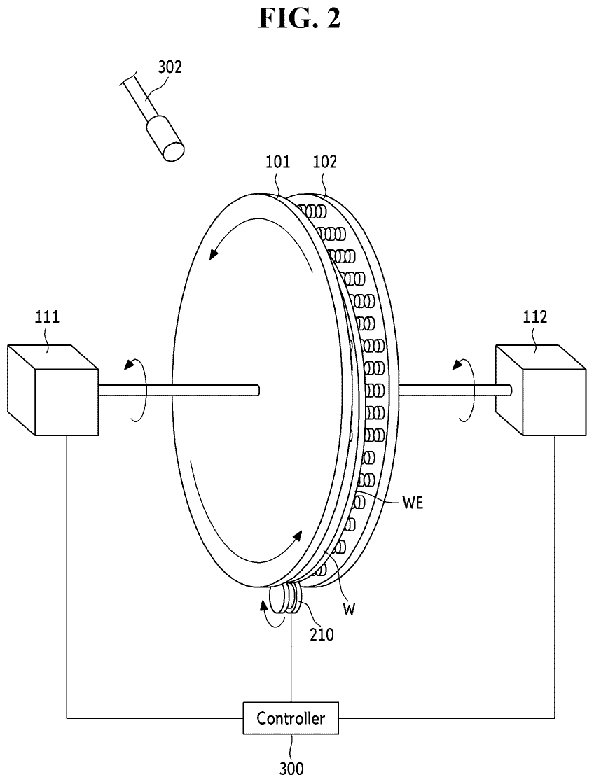

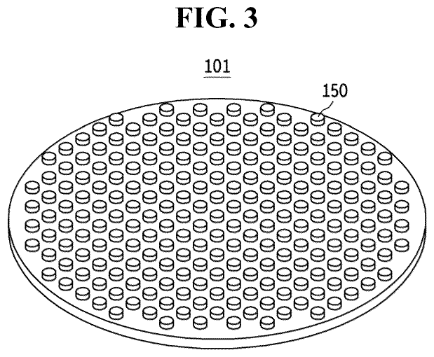

FIG. 1 is a cross-sectional view for explaining a substrate processing apparatus according to some embodiments of the present disclosure. FIG. 2 is a perspective view for explaining the substrate processing apparatus according to some embodiments of the present disclosure. FIG. 3 is a perspective view for explaining a brush of FIG. 1. Although only a first brush 101 is shown in FIG. 3 for convenience of explanation, a second brush 102 may also include the same form as the first brush 101.

Referring to FIGS. 1 to 3, the substrate processing apparatus according to some embodiments of the present disclosure may include the first brush 101, the second brush 102, a first driver 111, a second driver 112, a substrate driver 210, an injector 302, and a controller 300.

The first brush 101 and the second brush 102 may have a disk shape. The first brush 101 may include a first cleaning face S1. The second brush 102 may include a second cleaning face S2. The first cleaning face S1 and the second cleaning face S2 may be disposed to face each other.

The first brush 101 and the second brush 102 may include, for example, Polyvinyl Alcohol (PVA). The first brush 101 and the second brush 102 may include the same material, but are not limited to thereto. As another example, the first brush 101 and the second brush 102 may include different materials from each other.

The first brush 101 and the second brush 102 may be disposed to overlap each other. For example, a rotary axis C1 of the first brush 101 and a rotary axis C2 of the second brush 102 may be disposed on the same line. For example, the first brush 101 and the second brush 102 may be disposed symmetrically with a substrate W interposed therebetween, but are not limited thereto.

A plurality of nodules 150 (see FIG. 3) may be disposed on the surface of the first cleaning face S1. The plurality of nodules 150 may be disposed to protrude above a surface of the first cleaning face S1. All of the plurality of nodules 150 may have the same size and height. The plurality of nodules 150 may be arranged regularly at uniform intervals, but the number and arrangement of the plurality of nodules 150 are not limited to the number and arrangement shown in FIG. 3.

The plurality of nodules 150 may be disposed on the surface of the second cleaning face S2. The plurality of nodules 150 may be disposed to protrude above the surface of the second cleaning face S2. All of the plurality of nodules 150 may have the same size and height. For example, the plurality of nodules 150 may include PVA.

The plurality of nodules 150 disposed on the surface of the first cleaning face S1 and the plurality of nodules 150 disposed on the surface of the second cleaning face S2 may include, but are not limited to, the same placement. As another example, the number of the plurality of nodules 150 disposed on the surface of the first cleaning face S1 may be different from the number of the plurality of nodules 150 disposed on the surface of the second cleaning face S2.

The first cleaning face S1 may be disposed to face a first face W1 of the substrate W to be described below. The first cleaning face S1, including the plurality of nodules 150 thereof, may clean the first face W1 of the substrate W by being rotated by the first driver 111 in the state of being in contact with the first face W1. The second cleaning face S2 may be disposed to face a second face W2 of the substrate W, which will be described below. The second cleaning face S2, including the plurality of nodules 150 thereof, may clean the second face W2 of the substrate W by being rotated by the second driver 112 in the state of being in contact with the second face W2. Each of the first cleaning face S1 and the second cleaning face S2 (e.g., the plurality of nodules 150 thereof) may simultaneously come into contact with the first face W1 and the second face W2 of the substrate, and may simultaneously clean them.

Hereinafter, an area of the first cleaning face S1 refers to a cross-sectional area, not a surface area, obtained by adding up all the areas of the plurality of nodules 150 disposed on the first cleaning face S1. Hereinafter, an area of the second cleaning face S2 refers to the cross-sectional area, not a surface area, obtained by adding up all the areas of the plurality of nodules 150 disposed on the second cleaning face S2.

The area (and/or width) of the first cleaning face S1 may be larger than the area (and/or width) of the first face W1. The area (and/or width) of the second cleaning face S2 may be larger than the area (and/or width) of the second face W2. Although the area (and/or width) of the first cleaning face S1 and the area (and/or width) of the second cleaning face S2 are shown as being the same, embodiments of the present disclosure are not limited thereto. As another example, the area (and/or width) of the first cleaning face S1 may be smaller than the area (and/or width) of the second cleaning face S2.

The first driver 111 may be connected to the first brush 101. The first brush 101 may be rotated by the first driver 111. In other words, the first driver 111 provides power to the first brush 101 so that the first brush 101 may rotate. For example, the first driver 111 may make the first brush 101 rotate in a clockwise direction. As another example, the first driver 111 may make the first brush 101 rotate in a counterclockwise direction.

The second driver 112 may be connected to the second brush 102. The second brush 102 may be rotated by the second driver 112. In other words, the second driver 112 provides power to the second brush 102 so that the second brush 102 may rotate. For example, the second driver 112 may make the second brush 102 rotate in the clockwise direction. However, embodiment of the present disclosure are not limited thereto. As another example, the second brush 102 may rotate along the substrate W rotated by the first brush 101. That is, the second brush 102 may rotate along the substrate W by a frictional force with the substrate W without being rotated by the second driver 112.

The rotary axis C1 of the first brush 101, around which the first driver 111 rotates the first brush 101, may be the same as the rotary axis C2 of the second brush 102, around which the second driver 112 rotates the second brush 102. The first brush 101 may be rotated by the first driver 111 in a first direction. The second brush 102 may be rotated by the first driver 111 in the first direction. Each of the first brush 101 and the second brush 102 may be rotated in the same direction by the first driver 111 and the second driver 112.

A speed at which the first brush 101 rotates may be the same as a speed at which the second brush 102 rotates, but is not limited thereto. As another example, the first brush 101 may rotate faster than the second brush 102.

The first driver 111 may not only rotate the first cleaning face S1, but also move it vertically and horizontally. For example, the first driver 111 may rotate the first cleaning face S1 and move it vertically and horizontally at the same time.

The second driver 112 may not only rotate the second brush 102, but also move it vertically and horizontally. For example, the second driver 112 may rotate the second cleaning face S2 and move it vertically and horizontally at the same time.

According to some example embodiments of the present disclosure, the first driver 111 and/or the second driver 112 may include at least one actuator (e.g., a motor).

The substrate W may be provided between the first brush 101 and the second brush 102. The substrate W may include a peripheral part WE, and the first face W1 and the second face W2 that are opposite to each other. The first face W1 of the substrate W may be disposed to face the first cleaning face S1 of the first brush 101. The second face W2 of the substrate W may be disposed to face the second cleaning face S2 of the second brush 102.

The substrate W may include, for example, silicon (Si). The substrate W may include a semiconductor material such as germanium (Ge), or a compound semiconductor material such as silicon carbide (SiC), gallium arsenide (GaAs), indium arsenide (InAs), and indium phosphide (InP). Here, a diameter of the substrate W may be, but not limited to, about 300 mm. As another example, the diameter of the substrate W may be about 150 mm, about 200 mm, or about 450 mm, or more.

The substrate W may be for manufacturing either a memory element or a non-memory element. According to some embodiments, the memory element may be a non-volatile NAND flash memory (NAND-type flash memory). According to some embodiments, the memory element may include a phase-change random access memory (PRAM), a magnetoresistive random access memory (MRAM), a resistive random access memory (ReRAM), a ferroelectric random access memory (FRAM), a NOR flash memory, etc. The memory element may also be a volatile memory element, such as a dynamic random access memory (DRAM) and a static random access memory (SRAM) in which data is lost when the power supply is cut off. According to some embodiments, the memory element may be a logic chip or a measurement element, a communication element, a digital signal processor (DSP), a system-on-chip (SOC), or the like.

The substrate W may be connected to the substrate driver 210. For example, the peripheral part WE of the substrate W may come into contact with the substrate driver 210. The substrate W may be rotated by the substrate driver 210. In other words, the substrate driver 210 provides power to the substrate W such that the substrate W may rotate. For example, the substrate driver 210 may make the substrate W rotate in a clockwise direction. According to another example, the substrate driver 210 may make the substrate W rotate in a counterclockwise direction. According to some example embodiments of the present disclosure, the substrate driver 210 may include at least one actuator (e.g., a motor).

A rotary axis CW of the substrate W rotated by the substrate driver 210 is different from the rotary axis C1 of the first brush 101 rotated by the first driver 111. The rotary axis CW of the substrate W, around which substrate W is rotated by the substrate driver 210, may be different from the rotary axis C2 of the second brush 102, around which the second brush 102 is rotated by the second driver 112. That is, the rotary axis C1 of the first brush 101, the rotary axis CW of the substrate W, and the rotary axis C2 of the second brush 102 may not disposed on the same line.

Because the rotary axis C1 of the first brush 101, the rotary axis CW of the substrate W, and the rotary axis C2 of the second brush 102 are not disposed on the same line, the substrate W may evenly come into contact with the first brush 101 and the second brush 102. That is, the substrate W may be evenly cleaned by the first brush 101 and the second brush 102. For example, a region close to the peripheral part WE of the substrate W, and a region close to the center of the substrate W may be evenly cleaned. As another example, the first face W1 and the second face W2 of the substrate W may be evenly cleaned.

A rotary direction of the substrate W due to rotation by the substrate driver 210 may be the same as a rotary direction of the first brush 101 due to rotation by the first driver 111. The rotary direction of the substrate W due to rotation by the substrate driver 210 may be the same as the rotary direction of the second brush 102 due to rotation by the second driver 112. For example, when the first driver 111 rotates in the clockwise direction, the substrate driver 210 rotates in the counterclockwise direction such that the substrate W may rotate in the clockwise direction. As another example, when the second driver 112 rotates in the clockwise direction, the substrate driver 210 rotates in the counterclockwise direction such that the substrate W may rotate in the clockwise direction. Because all of the substrate W, the first brush 101, and the second brush 102 rotate in the same direction, it is possible to prevent damage to the substrate W due to a pressure, a friction, or the like between the substrate W and the first brush 101 and the second brush 102.

The injector 302 may be disposed above the first brush 101 and the second brush 102. The injector 302 may include a plurality of holes, and may provide cleaning liquid to the first brush 101 and the second brush 102. For example, the injector 302 may be a shower head. The injector 302 may provide the cleaning liquid between the first brush 101 and the first face S1, and between the second brush 102 and the second face S2.

The cleaning liquid may include, for example, a hydrofluoric acid (HF) solution, or may include citric acid (C₆H₈O₇), ammonia (NH₃) and/or hydrogen peroxide (H₂O₂), or a mixed solution thereof. The hydrofluoric acid (HF) solution may be a solution diluted with deionized water. For example, the hydrofluoric acid (HF) solution may be a solution containing 0.5% hydrofluoric acid (HF) in deionized water, but is not limited thereto. As another example, the cleaning liquid may be distilled water.

According to some embodiments of the present disclosure, the injector 302 may include a cleaning liquid tank, a distilled water tank, a cleaning liquid pipe, a cleaning liquid nozzle, a distilled water pipe, and a distilled water nozzle. The cleaning liquid stored in the cleaning liquid tank may be supplied onto the first cleaning face S1 and the second cleaning face S2 through the cleaning liquid nozzle via the cleaning liquid pipe.

The controller 300 may control the movements of the first driver 111, the second driver 112, and the substrate driver 210. For example, the controller 300 may control the rotary speeds and rotary directions of the first driver 111 and the second driver 112. Alternatively or additionally, the controller 300 may control the rotary speed and rotary direction of the substrate driver 210.

The controller 300 may control the first driver 111 to move vertically and horizontally. For example, the controller 300 causes the first driver 111 to move vertically, such that the first brush 101 may perform a sweeping motion on the first face W1 of the substrate W. As another example, the controller 300 causes the second driver 112 to move horizontally, such that the second brush 102 may perform the sweeping motion on the second face W2 of the substrate W.

The controller 300 may adjust the time, direction, and strength at which the cleaning liquid is injected from the injector 302. For example, the controller 300 may cause the cleaning liquid to be injected from the injector 302 toward the first face W1 and the second face W2 of the substrate W.

According to some embodiments of the present disclosure, the first brush 101, the second brush 102, the first driver 111, the second driver 112, the substrate driver 210, and the injector 302 may be disposed in a chamber. The chamber may have, for example, but not limited to, a rectangular pillar shape. As another example, the chamber may have a cylindrical shape.

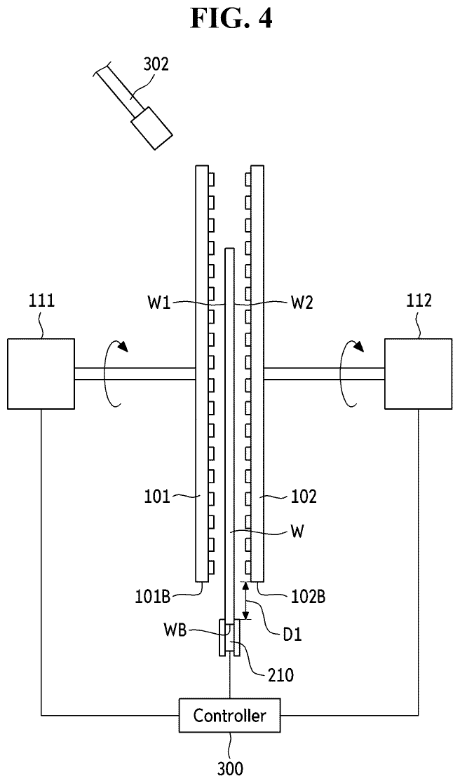

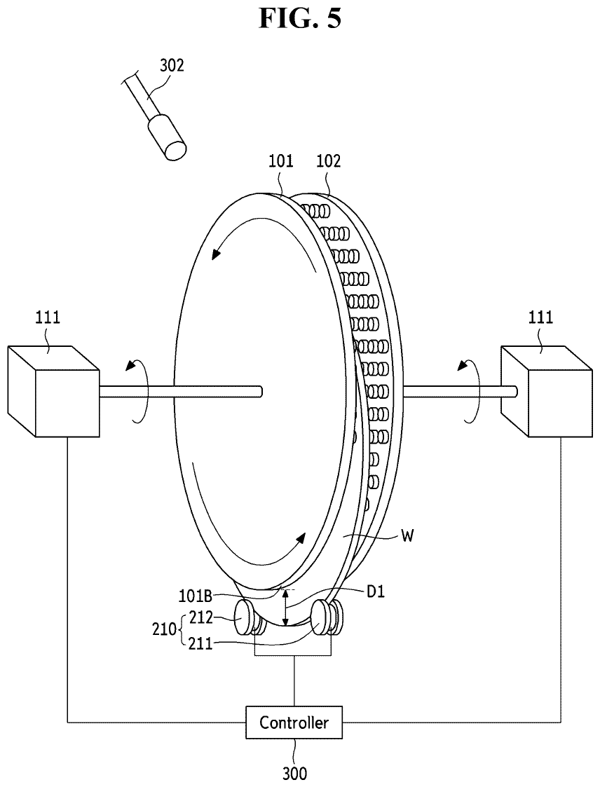

FIG. 4 is a cross-sectional view for explaining a substrate processing apparatus according to an embodiment of the present disclosure. FIG. 5 is a perspective view for explaining the substrate processing apparatus of FIG. 4 according to an embodiment of the present disclosure. For convenience of explanation, differences of FIGS. 4 and 5 from FIGS. 1 to 3 will be mainly explained below, and repeated descriptions thereof may be omitted.

Referring to FIGS. 4 and 5, the substrate W may be disposed between the first brush 101 and the second brush 102. A lower face 101B of the first brush 101 and a lower face 102B of the second brush 102 may be disposed on the same plane. The lower face 101B of the first brush 101 may not be disposed on the same plane as a lower face WB of the substrate W. The lower face 102B of the second brush 102 may not be disposed on the same plane as the lower face WB of the substrate W.

The lower face WB of the substrate W may be disposed to be lower than the lower face 101B of the first brush 101. The lower face WB of the substrate W may be disposed to be lower than the lower face 102B of the second brush 102. For example, the lower face WB of the substrate W may be disposed to be lower than the lower face 101B of the first brush 101 by a first distance D1. The lower face WB of the substrate W may be disposed to be lower than the lower face 102B of the second brush 102 by the first distance D1.

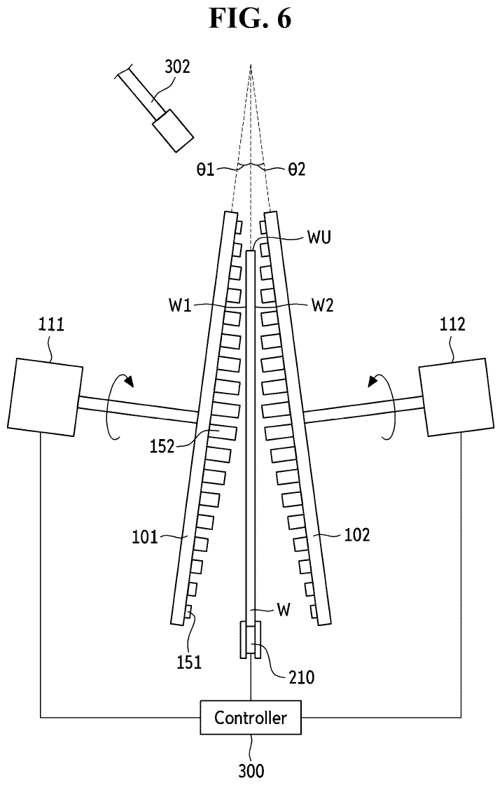

The substrate driver 210 may include a first substrate driver 211 and a second substrate driver 212. The first substrate driver 211 and the second substrate driver 212 may rotate in the same direction as each other. For example, the first substrate driver 211 and the second substrate driver 212 may rotate in the clockwise direction. Although only two substrate drivers (e.g., the first substrate driver 211 and the second substrate driver 212) are shown in FIG. 6, embodiments of the present disclosure are not limited thereto. As another example, three or more substrate drivers 210 may be provided.

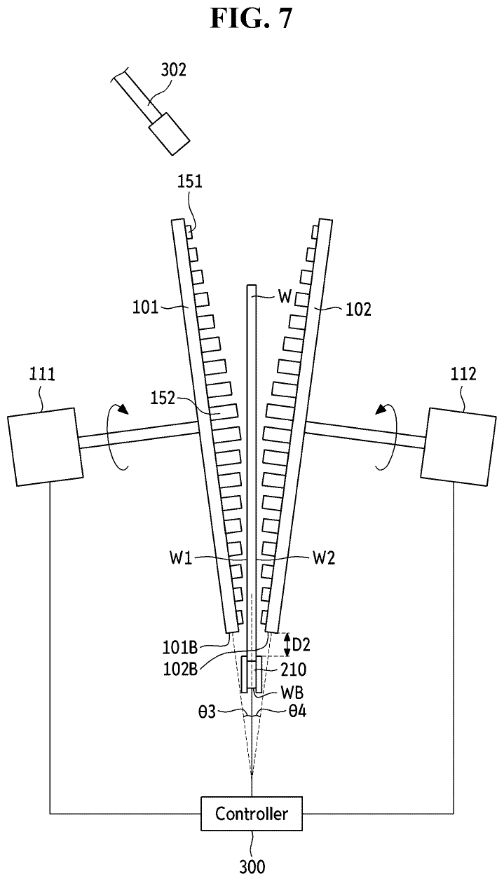

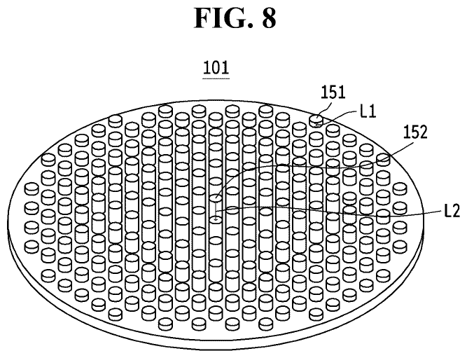

FIGS. 6 and 7 are cross-sectional views for explaining a substrate processing apparatus according to an embodiment of the present disclosure. FIG. 8 is a perspective view for explaining the brush of FIGS. 6 and 7. For convenience of explanation, although only the first brush 101 is shown in FIG. 8, the second brush 102 may also include the same form as the first brush 101. For convenience of explanation, differences of FIGS. 6 to 8 from FIGS. 1 to 3 will be mainly explained below, and repeated descriptions thereof may be omitted.

Referring to FIGS. 6 to 8, the first driver 111 and the second driver 112 may be disposed such that the first brush 101 and the second brush 102 approach the substrate W in a direction toward the upper face WU of the substrate W. The first driver 111 and the first brush 101 may be tilted at a first angle θ1 with respect to the substrate W. The second driver 112 and the second brush 102 may be tilted at a second angle θ2 with respect to the substrate W. Although the first angle θ1 and the second angle θ2 may be the same, embodiments of the present disclosure are not limited thereto. As another example, the first angle θ1 may be greater than the second angle θ2.

In contrast, the first driver 111 and the second driver 112 may position the first brush 101 and the second brush 102 to approach the substrate W in a direction toward the lower face WB of the substrate W. The first driver 111 and the first brush 101 may be tilted at a third angle θ3 with respect to the substrate W. The second driver 112 and the second brush 102 may be tilted at a fourth angle θ4 with respect to the substrate W. Although the third angle θ3 and the fourth angle θ4 may be the same, embodiments of the present disclosure are not limited thereto. As another example, the third angle θ3 may be greater than the fourth angle θ4.

The lower face WB of the substrate W may be disposed to be lower than the lower face 101B of the first brush 101. The lower face WB of the substrate W may be disposed to be lower than the lower face 102B of the second brush 102. For example, the lower face WB of the substrate W may be disposed to be lower than the lower face 101B of the first brush 101 by a second distance D2. The lower face WB of the substrate W may be disposed to be lower than the lower face 102B of the second brush 102 by the second distance D2.

The controller 300 may dispose the first driver 111 and the first brush 101 to be tilted at the first angle θ1 with respect to the substrate W. The controller 300 may dispose the second driver 112 and the second brush 102 to be tilted at the second angle θ2 with respect to the substrate W. Although the controller 300 may control the first driver 111 and the second driver 112 to be disposed symmetrically with each other, embodiments of the present disclosure are not limited thereto. As another example, the controller 300 may differently dispose the first angle θ1 at which the first driver 111 and the first brush 101 are tilted with respect to the substrate W, and the second angle θ2 at which the second driver 112 and the second brush 102 are tilted with respect to the substrate W.

The controller 300 may dispose the first driver 111 and the first brush 101 to be tilted at the third angle θ3 with respect to the substrate W. The controller 300 may dispose the second driver 112 and the second brush 102 to be tilted at the fourth angle θ4 with respect to the substrate W. Although the controller 300 may control the first driver 111 and the second driver 112 to be disposed symmetrically with each other, embodiments of the present disclosure are not limited thereto. As another example, the controller 300 may differently dispose the third angle θ3 at which the first driver 111 and the first brush 101 are tilted with respect to the substrate W, and the fourth angle θ4 at which the second driver 112 and the second brush 102 are tilted with respect to the substrate W.

The controller 300 may dispose the first driver 111 and the first brush 101 to be tilted at the first angle θ1 with respect to the substrate W, and then dispose the first driver 111 and the first brush 101 to be tilted at the third angle θ3 with respect to the substrate W. In other words, the controller 300 may change the angle and positional relationship between the first driver 111 (and the first brush 101) and the substrate W.

The controller 300 may dispose the second driver 112 and the second brush 102 to be tilted at the second angle θ2 with respect to the substrate W, and then dispose the second driver 112 and the second brush 102 to be tilted at the fourth angle θ4 with respect to the substrate W. In other words, the controller 300 may change the angle and positional relationship between the second driver 112 (and the second brush 102) and the substrate W.

The controller 300 may dispose the lower face WB of the substrate W to be lower than the lower face 101B of the first brush 101 by the second distance D2. In other words, the controller 300 may control the position of the substrate W.

Although the plurality of nodules 150 disposed on the surface of the first cleaning face S1 and the plurality of nodules 150 disposed on the surface of the second cleaning face S2 may include the same placement, embodiments of the present disclosure are not limited thereto. As another example, the number of the plurality of nodules 150 disposed on the surface of the first cleaning face S1 may be different from the number of the plurality of nodules 150 disposed on the surface of the second cleaning face S2.

The shapes of the plurality of nodules 150 disposed on each of the surfaces of the first cleaning face S1 and the second cleaning face S2 may be different from each other. For example, a length L2 of any one of the nodules 152 disposed close to the central part of the surface of the first cleaning face S1 may be longer than a length L1 of any one of the nodules 151 disposed close to the peripheral part of the surface of the first cleaning face S1.

Because the length L2 of any one of the nodules 152 disposed close to the central part of the surface of the first cleaning face S1 is different from the length L1 of any one of the nodules 151 disposed close to the peripheral part of the surface of the first cleaning face S1, each of the first cleaning face S1 and the second cleaning face S2 may evenly come into contact with the first face W1 and the second face W2 of the substrate W. As a result, the substrate W may be evenly cleaned.

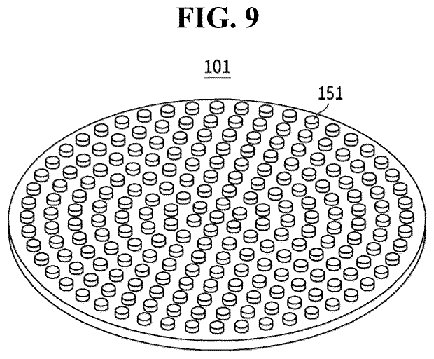

FIG. 9 is a perspective view for explaining a brush according to an embodiment of the present disclosure. For convenience of explanation, differences of FIG. 9 from FIG. 3 will be mainly explained. For reference, although only the first brush 101 is shown in FIG. 9, the second brush 102 may also include the same shape as the first brush 101. For reference, the first brush 101 shown in FIG. 9 may correspond to the first brush 101 shown in FIG. 1.

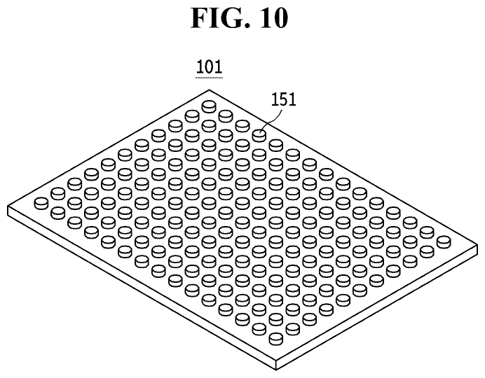

Referring to FIG. 9, a plurality of nodules 150 may be disposed on the surface of the first brush 101. Although the plurality of nodules 150 may be regularly arranged in a circular array having one center, the number and arrangement of the plurality of nodules 150 are not limited to the shape of the first brush 101 shown in FIG. 10.

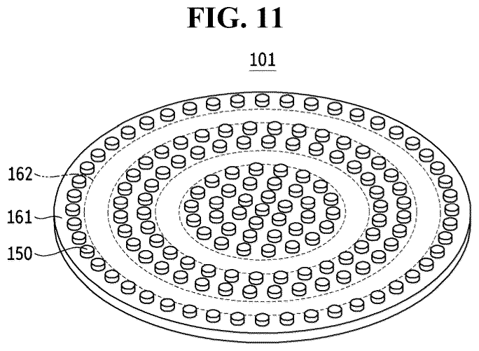

FIG. 10 is a perspective view for explaining a brush according to an embodiment of the present disclosure. For convenience of explanation, differences of FIG. 10 from FIG. 3 will be mainly explained. For reference, although only the first brush 101 is shown in FIG. 10, the second brush 102 may also include the same shape as the first brush 101. For reference, the first brush 101 shown in FIG. 11 may correspond to the first brush 101 shown in FIG. 1.

Referring to FIG. 10, the first brush 101 may be a square. In other words, the first brush 101 may include other shapes that are not a circle. As another example, the first brush 101 may be a pentagon or a hexagon. Although the plurality of nodules 150 disposed on the surface of the first brush 101 may be disposed regularly in columns and rows, embodiments of the present disclosure are not limited thereto.

FIG. 11 is a perspective view for explaining a brush according to an embodiment of the present disclosure. For convenience of explanation, differences of FIG. 11 from FIG. 3 will mainly be explained. For reference, although only the first brush 101 is show in FIG. 11, the second brush 102 may also include the same shape as the first brush 101. For reference, the first brush 101 shown in FIG. 11 may correspond to the first brush 101 shown in FIG. 1.

Referring to FIG. 11, the first brush 101 may include a first region 161 and a second region 162. A plurality of nodules 150 may be disposed in the first region 161. The plurality of nodules 150 may not be disposed in the second region 162. When a cleaning solution is provided onto the first brush 101, the cleaning solution may easily flow into the central part of the first brush 101 through the second region 162.

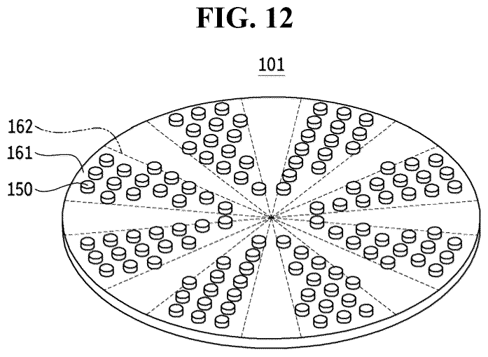

The first region 161 and the second region 162 may be disposed in an alternating manner on a basis of a distance from the center of the first brush 101. In other words, the first region 161 and the second region 162 may be repeatedly disposed in a direction away from the center of the first brush 101. Although FIG. 12 shows that the first region 161 is disposed at the center of the first brush 101, embodiments of the present disclosure are not limited thereto. As another example, the second region 162 may be disposed at the center of the first brush 101.

FIG. 12 is a perspective view for explaining a brush according to an embodiment of the present disclosure. For convenience of explanation, differences of FIG. 12 from FIG. 3 will be mainly explained. For reference, although only the first brush 101 is shown in FIG. 12, the second brush 102 may also include the same form as the first brush 101. For reference, the first brush 101 shown in FIG. 12 may correspond to the first brush 101 shown in FIG. 1.

Referring to FIG. 12, the first brush 101 may include a first region 161 and a second region 162. A plurality of nodules 150 may be disposed in the first region 161. The plurality of nodules 150 may not be disposed in the second region 162. When a cleaning solution is provided onto the first brush 101, the cleaning solution may easily flow into the center of the first brush 101 through the second region 162.

The first region 161 and the second region 162 may be disposed in an alternating manner in a circumferential direction of the first brush 101. In other words, the first region 161 and the second region 162 may be repeatedly disposed along the circumferential direction of the first brush 101. Although FIG. 12 shows a case where the area of the first region 161 is greater than the area of the second region 162, embodiments of the present disclosure are not limited thereto. As another example, the area of the first region 161 may be equal to the area of the second region 162.

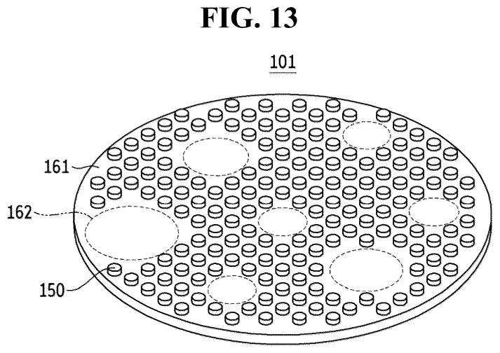

FIG. 13 is a perspective view for explaining a brush according to an embodiment of the present disclosure. For convenience of explanation, differences of FIG. 13 from FIG. 3 will be mainly explained. For reference, although only the first brush 101 is shown in FIG. 13, the second brush 102 may also include the same form as the first brush 101. For reference, the first brush 101 shown in FIG. 13 may correspond to the first brush 101 shown in FIG. 1.

Referring to FIG. 13, the first brush 101 may include a first region 161 and a second region 162. The plurality of nodules 150 may be disposed in the first region 161. The plurality of nodules 150 may not be disposed in the second region 162. When a cleaning solution is provided onto the first brush 101, the cleaning solution may easily flow into the center of the first brush 101 through the second region 162.

The first region 161 and the second region 162 may be disposed randomly without any rules. In other words, the first region 161 and the second region 162 may be disposed freely on the surface of the first brush 101. A plurality of second regions 162 may be disposed on the first brush 101. The sizes and areas of each second region 162 may be different from each other.

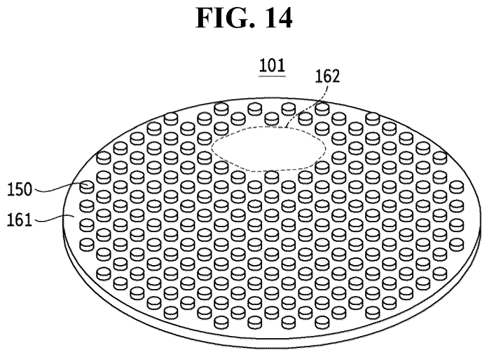

FIG. 14 is a perspective view for explaining a brush according to an embodiment of the present disclosure. For convenience of explanation, differences of FIG. 14 from FIG. 3 will be mainly explained. For reference, although only the first brush 101 is shown in FIG. 14, the second brush 102 may also include the same shape as the first brush 101. For reference, the first brush 101 shown in FIG. 14 may correspond to the first brush 101 shown in FIG. 1.

Referring to FIG. 14, the first brush 101 may include a first region 161 and a second region 162. The plurality of nodules 150 may be disposed in the first region 161. The plurality of nodules 150 may not be disposed in the second region 162. When the cleaning solution is provided onto the first brush 101, the cleaning solution may easily flow into the center of the first brush 101 through the second region 162.

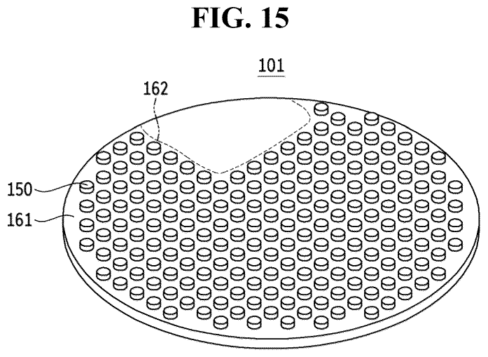

The second region 162 may be disposed to be surrounded by the first region 161. The second region 162 may be disposed not to be in contact with the periphery of the first brush 101. Although FIG. 15 shows that the second region 162 has a random shape without a specific shape, embodiments of the present disclosure are not limited thereto. As another example, the shape of the second region 162 may be a circle and a polygon.

FIG. 15 is a perspective view for explaining a brush according to an embodiment of the present disclosure. For convenience of explanation, differences of FIG. 15 from FIG. 3 will be mainly explained. For reference, although only the first brush 101 is shown in FIG. 15, the second brush 102 may also include the same shape as the first brush 101. For reference, the first brush 101 shown in FIG. 15 may correspond to the first brush 101 shown in FIG. 1.

Referring to FIG. 15, the first brush 101 may include a first region 161 and a second region 162. The plurality of nodules 150 may be disposed in the first region 161. The plurality of nodules 150 may not be disposed in the second region 162. When a cleaning solution is provided onto the first brush 101, the cleaning solution may easily flow into the center of the first brush 101 through the second region 162.

The second region 162 may be disposed to abut the periphery of the first brush 101. The remaining portions of the first brush 101 in which the second region 162 does not abut the periphery of the second brush 102 may be included in the first region 161. Although FIG. 15 shows that the second region 162 has a random shape without a specific shape, embodiments of the present disclosure are not limited thereto. As another example, the shape of the second region 162 may be a circle and a polygon.

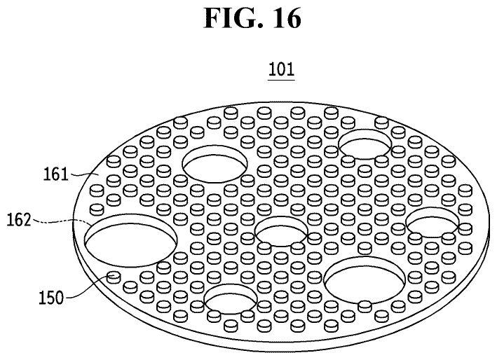

FIG. 16 is a perspective view for explaining a brush according to an embodiment of the present disclosure. For convenience of explanation, differences of FIG. 16 from FIG. 3 will be mainly explained. For reference, although only the first brush 101 is shown in FIG. 16, the second brush 102 may also include the same shape as the first brush 101. For reference, the first brush 101 shown in FIG. 16 may correspond to the first brush 101 shown in FIG. 1.

Referring to FIG. 16, the first brush 101 may include a first region 161, and a second region 162 that penetrates the first brush 101. The plurality of nodules 150 may be disposed in the first region 161. The second region 162 refers to a penetrating region of (e.g., a hole in) the first brush 101.

The first region 161 and the second region 162 may be disposed randomly without any rule. In other words, the first brush 101 may include a plurality of holes disposed randomly. The sizes of each second region 162 may be different from each other. The cleaning solution may be easily provided to the first region 161 of the first brush 101 through the second region 162.

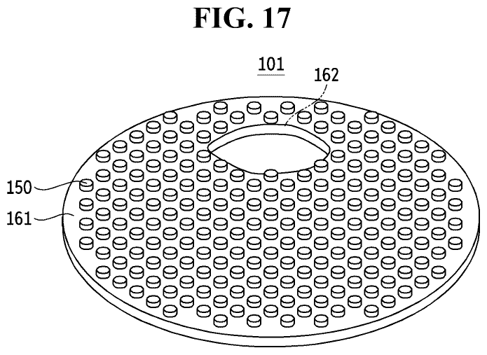

FIG. 17 is a perspective view for explaining a brush according to an embodiment of the present disclosure. For convenience of explanation, differences of FIG. 17 from FIG. 3 will be mainly explained. For reference, although only the first brush 101 is shown in FIG. 17, the second brush 102 may also include the same shape as the first brush 101. For reference, the first brush 101 shown in FIG. 17 may correspond to the first brush 101 shown in FIG. 1.

Referring to FIG. 17, the first brush 101 may include a first region 161, and a second region 162 that penetrates the first brush 101. The plurality of nodules 150 may be disposed in the first region 161. The second region 162 refers to the penetrating region of (e.g., a hole in) the first brush 101.

The first region 161 and the second region 162 may be disposed randomly without any rule. In other words, the first brush 101 may include holes that are disposed randomly. When the cleaning solution is provided onto the first brush 101, the cleaning solution may easily flow into the first region 161 through the second region 162. Although FIG. 17 shows that the second region 162 has a random shape without a specific shape, embodiments of the present disclosure are not limited thereto. As another example, the shape of the second region 162 may be a circle and a polygon.

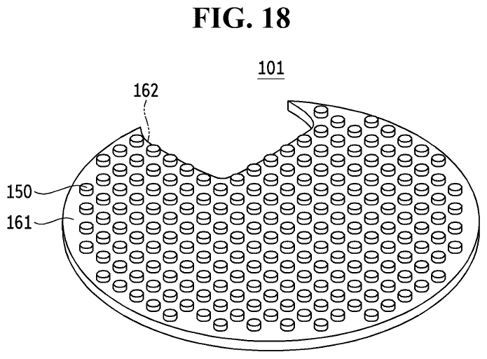

FIG. 18 is a perspective view for explaining a brush according to an embodiment of the present disclosure. For convenience of explanation, differences of FIG. 18 from FIG. 3 will be mainly explained. For reference, although only the first brush 101 is shown in FIG. 18, the second brush 102 may also include the same shape as the first brush 101. For reference, the first brush 101 shown in FIG. 18 may correspond to the first brush 101 shown in FIG. 1.

Referring to FIG. 18, the first brush 101 may include a first region 161, and a second region 162 that penetrates the first brush 101. A plurality of nodules 150 may be disposed in the first region 161. The second region 162 refers to the penetrating region of (e.g., a hole in) the first brush 101.

The second region 162 may include a peripheral part of the first brush 101. When the cleaning solution is provided onto the first brush 101, the cleaning solution may easily flow into the first region 161 through the second region 162. Although FIG. 18 shows that the second region 162 has a random shapes without a particular shape, embodiments of the present disclosure are not limited thereto. As another example, the shape of the second region 162 may be a circle and a polygon.

According to some example embodiments of the present disclosure, the controller 300 may include at least one processor, such as a central processing unit (CPU), a graphic processing unit (GPU), and/or another type of microprocessor, and an internal memory to perform functions of the controller 300 described herein (e.g., the above-described functions) and/or other functions by loading corresponding computer code or instructions on the internal memory and execute the computer code or instructions.

Those skilled in the art will appreciate that many variations and modifications may be made to the example embodiments of the present disclosure without departing from the spirit and scope of the present disclosure. Therefore, the described example embodiments of the present disclosure are used in a generic and descriptive sense only and not for purposes of limitation.

What is claimed is:

1. A substrate processing apparatus comprising:
a substrate comprising a first face and a second face that are opposite to each other;
a substrate driver configured to come into contact with a peripheral part of the substrate, and provide a driving force to the substrate to rotate the substrate;
a first brush that faces the first face, and is configured to clean the first face by coming into contact with the first face and rotating in a first direction;
a second brush that faces the second face, and is configured to clean the second face by coming into contact with the second face and rotating in the first direction; and
a controller configured to control at least one from among the substrate driver, the first brush, and the second brush,
wherein the first brush comprises a first cleaning face configured to come into contact with the first face, and
wherein the second brush comprises a second cleaning face configured to come into contact with the second face.

2. The substrate processing apparatus of claim 1, wherein the first cleaning face and the second cleaning face have a same width as each other.

3. The substrate processing apparatus of claim 1, wherein a width of the first cleaning face is greater than a width of the first face, and
wherein a width of the second cleaning face is greater than the width of the second face.

4. The substrate processing apparatus of claim 1, further comprising:
a first driver configured to rotate the first brush in the first direction; and
a second driver configured to rotate the second brush in the first direction.

5. The substrate processing apparatus of claim 4, wherein the first driver is configured to rotate the first brush around a first rotary axis,
wherein the second driver is configured to rotate the second brush around a second rotary axis that is the same as the first rotary axis, and
wherein the substrate driver is configured to rotate the substrate around a third rotary axis that is different from the first rotary axis.

6. The substrate processing apparatus of claim 1, wherein the controller is further configured to control at least one from among the first brush and the substrate so that the first brush and the first face come into contact with each other at an acute angle for the first brush to clean a part of the first face.

7. The substrate processing apparatus of claim 1, wherein the controller is further configured to cause the first brush and the second brush to be parallel to each other.

8. The substrate processing apparatus of claim 1, wherein the first brush and the second brush overlap each other.

9. The substrate processing apparatus of claim 1, wherein the substrate driver is further configured to rotate the substrate in the first direction.

10. The substrate processing apparatus of claim 1, further comprising:
a plurality of nodules on surfaces of each of the first brush and the second brush,
wherein the plurality of nodules have a same size as each other.

11. The substrate processing apparatus of claim 1, further comprising:
a plurality of nodules on surfaces of each of the first brush and the second brush,
wherein the plurality of nodules have an increasing height toward a center of the surfaces of each of the first brush and the second brush.

12. The substrate processing apparatus of claim 1, wherein a cleaning face of each of the first brush and the second brush comprises a first region comprising a plurality of nodules, and a second region that does not comprise any nodules.

13. A substrate processing apparatus comprising:
a first brush comprising a first cleaning face;
a second brush comprising a second cleaning face, the second brush spaced apart from the first brush;
a substrate between the first brush and the second brush, the substrate comprising a first face that faces the first cleaning face, and a second face that faces the second cleaning face;
a substrate driver configured to come into contact with a peripheral part of the substrate, and provide a driving force to the substrate to rotate the substrate; and
a controller configured to control at least one from among the substrate driver, the first brush, and the second brush,
wherein the first cleaning face is configured to come into contact with an entirety of the first face,
wherein the second cleaning face is configured to come into contact with an entirety of the second face, and
wherein a width of the first cleaning face is greater than a width of the first face, and a width of the second cleaning face is greater than a width of the second face.

14. The substrate processing apparatus of claim 13, further comprising:
a first driver configured to rotate the first brush in a first direction; and
a second driver configured to rotate the second brush in the first direction.

15. The substrate processing apparatus of claim 13, wherein the first cleaning face and the second cleaning face have a same width.

16. The substrate processing apparatus of claim 13, wherein a lower face of the first brush and a lower surface of the second brush are on a same plane, and
wherein the lower face of the substrate is lower than the lower face of the first brush.

17. The substrate processing apparatus of claim 13, wherein the first brush is tilted to form a first angle with the substrate,
wherein the second brush is tilted to form the first angle with the substrate, and
wherein the first brush and the second brush are not in parallel to each other.

18. The substrate processing apparatus of claim 13, wherein a width of the first cleaning face is greater than a width of the first face, and
wherein a width of the second cleaning face is greater than a width of the second face.

19. The substrate processing apparatus of claim 13, wherein each of the first cleaning face of the first brush and the second cleaning face of the second brush comprises a first region comprising a plurality of nodules, and a second region that does not comprises any nodules.

20. A substrate processing apparatus comprising:
a substrate comprising a first face and a second face that are opposite to each other;
a substrate driver configured to come into contact with a peripheral part of the substrate, and provide a driving force to the substrate to rotate the substrate;
a first brush comprising a first cleaning face that faces the first face of the substrate, the first cleaning face configured to clean the first face of the substrate by coming into contact with the first face and rotating in a first direction;
a second brush comprising a second cleaning face that faces the second face of the substrate, the second cleaning face configured to clean the second face of the substrate by coming into contact with the second face and rotating in the first direction;
a first driver configured to rotate the first brush in the first direction;
a second driver configured rotate the second brush in the first direction;
an injector configured to provide a cleaning solution to the first brush and the second brush; and
a controller configured to control at least one from among the substrate driver, the first brush, and the second brush,
wherein a width of the first cleaning face is greater than a width of the first face,
wherein a width of the second cleaning face is greater than a width of the second face,
wherein the first driver is configured to rotate the first brush around a first rotary axis,
wherein the second driver is configured to rotate the second brush around a second rotary axis that is the same as the first rotary axis, and
wherein the substrate driver is configured to rotate the substrate around a third rotary axis that is different from the first rotary axis.
